(19) United States
(12) Patent Application Publication
(10) Pub. No.: US 2006/0230176 A1
(43) Pub. Date: Oct. 12, 2006

(54) Methods and apparatus for decreasing streaming latencies for IPTV

(76) Inventor: Behram Mario Dacosta, San Diego, CA (US)

Correspondence Address: O'BANION & RITCHEY LLP/ SONY ELECTRONICS, INC., 400 CAPITOL MALL, SUITE 1550, SACRAMENTO, CA, 95814, US

(21) Appl. No.: 11/333,907

(22) Filed: Jan. 17, 2006

Related U.S. Application Data
(63) Continuation-in-part of application No. 11/104,843, filed on Apr. 12, 2005.

(51) Int. Cl. H04N 7/173; G06F 15/16

(52) U.S. Cl. 709/235; 725/94

(57) ABSTRACT

Streaming latency in an internet protocol television (IPTV) system is decreased by providing a separate source of the selected A/V content to the user that is immediately available to the user when the user requests the A/V content, and that can be used until the requested A/V content is received from the service provider. The separate source can be a channel change stream (CCS) channel broadcast or multicast from the service provider to the user or a local user storage containing stored initial segments of the A/V content.

### CROSS-REFERENCE TO RELATED APPLICATIONS

This application is a continuation-in-part of U.S. application Ser. No. 11/104,843 filed on Apr. 12, 2005, incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND OF THE INVENTION

1. Field of the Invention

This invention pertains generally to A/V streaming systems, and more particularly to decreasing latency in internet protocol television (IPTV) streaming systems, both for broadcast/multicast and video-on-demand.

2. Description of Related Art

In a server-client A/V (audio-video or audio-visual) streaming system, the server streams video that is read from a source device, e.g. a hard-drive inside a personal video recorder (PVR). This A/V data is then transmitted to a remote client system, where the A/V data is output on a display device. In one particular application the client is located in the home environment, e.g. for entertainment or information systems. There are often multiple clients connected to one server.

The communication link between the Server and the Client may be based on powerline communications (PLC), wireless communications (e.g. 802.11), Ethernet, etc. What such communication links have in common is that they introduce packet jitter and burstiness into the system. Such jitter and burstiness is introduced by various factors such as packet retransmissions and the nature of data transfer between various subsystem components. Packet jitter is the variance of the interval between reception times of successive packets.

The effect of this jitter on the display on the client would to be cause artifacts and other defects in the displayed video. In order to reduce the effects of this jitter on the perceived A/V at the client, systems typically include data buffers at both the transmitter (Tx) and receiver (Rx), and also at intermediate nodes on the network. Such data buffers are implemented in software or hardware or both. Multiple such data buffers may be used on each of the Tx and Rx. For example, at the Tx, the driver reading the stream off the source device (e.g. a hard-disk drive (HDD)) would have a data buffer, the software application would have a data buffer, the network protocol stack would have a software buffer, and the communication link (e.g. 802.11x) driver would also have a data buffer. On the Rx side there are similar buffers for the communication link (e.g. 802.11x) driver, the network protocol stack, the software application, and the video display driver. Even though data may be stored in such buffers with substantial jitter and burstiness, the data can be read from these buffers whenever required, and hence the output of these buffers is usually not affected by the jitter of the input data.

The problem with such data buffers or software and hardware buffers is that they also introduce a latency into the streaming system. Such a latency degrades the user experience in the following way. When the user at the client system clicks on the “play” button of the graphic user interface (GUI) on the screen to play a program off the HDD at the server, there is a delay before the video actually starts playing, providing the user with a decreased sense of interactivity. A similar problem exists when the user changes the viewed program. The existing data from the previous program that was previously in the buffers must first be streamed out and displayed on the Client display before the new program A/V data that has just been added to the end of the pipeline finally can be displayed on the client.

Thus the problem of jitter can be dealt with by introducing buffers but undesirable latency is thereby also introduced into the system. Therefore it is necessary to reduce latency to improve the viewing experience.

One particular type of A/V streaming system is internet protocol television (IPTV), a new service that is being developed by broadband service providers. IPTV provides television (TV) communication of pictures and sound using internet protocol (IP) network formatting of packets and addressing schemes. IPTV services are provided over private IP networks, not the public internet. IPTV services will generally include both a multi-channel line-up similar to that presently offered by broadcast and cable TV services, and video-on-demand (VOD) programming. Along with IPTV, the service provider will typically offer other network services.

Despite its promise, IPTV also faces a number of problems. IPTV implementation can have large latencies that can degrade the user's experience. For example, channel change latencies may be large, and latencies for the initial start of VOD may also be large. The problem is that A/V streaming latencies are larger for TVs based on IP technology compared to TVs based on standard quadrature amplitude modulated (QAM) broadcast technology (e.g. cable TV). This increased latency results in greater delay between the consumer pressing the “next channel” button on the remote control and the consumer starting to see the next channel's A/V content. This increased latency can also result in several seconds delay from the time that a consumer selects VOD content from the service provider's server and the time that the selected content is actually displayed on the consumer's display.

There is a fundamental difference in how a TV (or STB, set-top box) receives IP based broadcast/multicast video content from an IPTV service provider, compared to how a STB/TV receives broadcast TV from a traditional cable QAM modulated service provider.

In the latter case, all broadcast channels are transmitted from the central office or head end to the customer premises equipment (CPE), e.g. STB. The STB then tunes the desired channel and displays the channel to the viewer. If the viewer changes the channel, another channel at the STB is tuned. Since content for this new channel was already being received (with all the other broadcast channels) at the STB, the only action required is local re-tuning at the STB. The main latencies are local and therefore are typically quite small, i.e. tuning latency, video codec decoding latency, and latencies caused by propagation of signals within the STB and TV to the actual display.

However, in the case of broadcast/multicast IPTV, the stream sent to the CPE (STB/TV) from the service provider contains only the content for the channel being viewed. If the user selects a new channel, then the STB/TV notifies the central office, head end, router, or other remotely located coordinating point that it would like to receive this new channel, and the stream change is made at the remote location. Hence, compared to traditional cable systems, there is a greater delay before the content from this new stream is visible on the TV. The increased delay is caused by the time for the “channel change” message to reach the remote location from the consumer's STB/TV, the time to implement and propagate the changes needed to route the stream for the new channel to the consumer, the time for the content to propagate via the network to the user's location, in addition to the latencies experienced for traditional cable systems as described above.

Video-on-Demand (VOD) refers to the selection of content to be viewed in real-time from the service provider's storage, and streaming of this content via unicast to the consumer. The consumer usually has “real-time” control of the stream using “fast-forward,” “pause,” “rewind” and other controls on a remote control device. The service provider may have 1000 movies available for viewing as VOD.

### BRIEF SUMMARY OF THE INVENTION

An aspect of the invention is a method for reducing latency due to buffers in an A/V streaming system, by streaming data into buffers in the A/V streaming system; holding streamed data in the buffers until removed; removing streamed data from the buffers for transmission or display; and flushing held data from the buffers in response to a change program command.

The method may further include sending initial segments of data from a source device to the buffers at a first rate, and sending the remaining segments of data from the source device to the buffers at a second rate higher than the first rate. The method may also include starting the buffers at an initial size when a program is first selected for viewing, and increasing the buffers as streaming continues until buffer size reaches a maximum.

Another aspect of the invention is a server-client A/V streaming system including a server, including buffers; a client, including buffers; a communications channel connecting the server and client; where the server and client each contain a control module which generates a flush buffer command in response to a user initiated change program command to flush the buffers in the server and client.

The communications channel is a wired or wireless channel. A source device is connected to the server, and a rate control unit may be connected to the source device. A display device is connected to the client, and a consumption control unit may be connected to the display device. The control module may also generate a buffer size control signal to increase the sizes of the buffers from initial sizes to maximum sizes.

A still further aspect of the invention is an improvement in a method for streaming A/V data from a source device to a server through a communication channel to a client to a display device through multiple buffers, comprising flushing the buffers in response to a change program signal to reduce latency. Further improvements include streaming initial segments of the data at a lower rate, and increasing the size of the buffers from an initial size to a maximum during streaming.

Another aspect of the invention is a method and apparatus for decreasing streaming latency in an internet protocol television (IPTV) system by providing a separate source of the selected A/V content to the user that is immediately available to the user when the user requests the A/V content, and that can be used until the requested A/V content is received from the service provider. The separate source can be a channel change stream (CCS) channel broadcast or multicast from the service provider to the user, which is particularly applicable to broadcast or multicast A/V content, or a local user storage containing stored initial segments of the A/V content, which is most applicable to VOD content.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a schematic diagram of an embodiment of a Server-Client apparatus according to the invention.

FIG. 2 is a flowchart of an embodiment of a method according to the invention.

FIG. 3 through FIG. 5 are flowcharts of additional methods of the invention.

FIG. 6 is a schematic diagram of an IPTV system embodying the invention of FIG. 1 through FIG. 5.

FIG. 7 is a simplified block diagram of an IPTV system with an additional embodiment of the invention for broadcast/multicast A/V delivery.

FIG. 8 is a flowchart of the method of the invention shown in FIG. 7.

FIG. 9 is a simplified block diagram of a VOD server-user CPE in an IPTV system with an additional embodiment of the invention for VOD.

FIG. 10 is a flowchart of the method of the invention shown in FIG. 9.

### DETAILED DESCRIPTION OF THE INVENTION

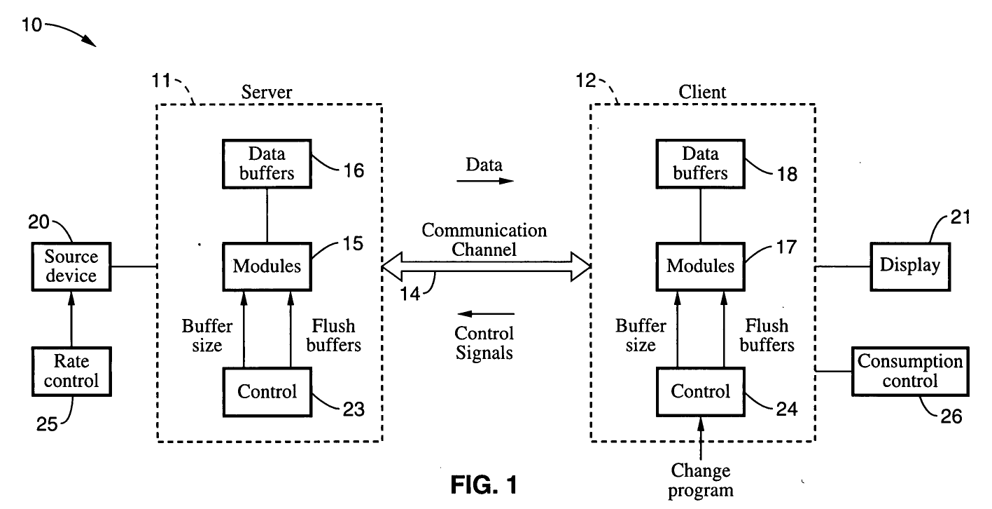

Referring more specifically to the drawings, for illustrative purposes the present invention is embodied in the methods and apparatus generally shown in FIG. 1 through FIG. 10. It will be appreciated that the apparatus may vary as to configuration and as to details of the parts, and that the methods may vary as to the specific steps and sequence, without departing from the basic concepts as disclosed herein.

The invention applies to a server-client A/V (audio-video or audio-visual) streaming system, such as a system where the client is located in a home environment. The server streams video that is read from a source and this A/V data is transmitted to a remote client system over a wired or wireless communication link. The communication link introduces packet jitter and burstiness into the system, which cause artifacts and other defects in the displayed video. Data buffers are included at both the Tx and Rx (and also at intermediate nodes) to reduce the effects of this jitter on the perceived A/V at the client. The buffers, however, introduce latency into the streaming system, which also affects the user's viewing experience. The invention is directed to reducing this latency.

FIG. 1 shows the basics of a server-client A/V streaming system 10, including a server 11 and a client 12. Server 11 and client 12 are connected together through a communication link or channel 14. Server 11 functions primarily as a transmitter to send A/V data to client 12 but can also receive information back from client 12. Client 12 functions primarily as a receiver of the A/V data from server 11 but can also transmit information back to server 11. Thus both are generally “transceivers”.

Server 11 contains a number of different modules 15 and associated data buffers 16. Client 12 also contains a number of different modules 17 and associated data buffers 18. As an example, modules 15 of server 11 may include a driver for reading the stream off a source device, the software application, a network protocol stack, and a communication link driver. Modules 17 of client 12 may include a communication link driver, a network protocol stack, the software application, and a video display driver. Buffers are associated with each of these components. The buffers may be implemented in either software or hardware or both.

The basic structures of servers and clients are well known in the art, and can be implemented in many different embodiments and configurations, so they are shown in these general representations of modules 15, 17 with buffers 16, 18. The invention does not depend on a particular physical implementation, configuration or embodiment thereof.

The server 11 streams video that is read from a source device 20, such as a hard-drive inside a personal video recorder (PVR). This A/V data is then passed and processed through modules 15 and buffers 16, and transmitted over communications channel 14 to a remote client system. At client 12 the A/V data is processed and passed through modules 17 and buffers 18, and output to a display device 21. Again, source devices and display devices are well known in the art, and will not be described further. The invention does not require particular source or display devices.

The communication link 14 between the server 11 and the client 12 may be wired or wireless. For example, link 14 may be based on Powerline communications (PLC), Wireless communications, Ethernet, etc. Wireless communications may use IEEE standard 802.11x wireless local area networks (WLANs). Again, the invention does not depend on the particular technology used for the communication channel.

The most basic embodiment of the invention for reducing latency is the flushing of buffers. If a user is already viewing a program and then changes the program being viewed (e.g. using a “channel change” command), control commands are sent to the modules within the server and the client to flush the data buffers. This decreases the latency with which the user sees the new program on the client display.

The control commands are not usually delayed in their transmission across the communication link (i.e. they are not affected by buffer latency) for two reasons. First, the control commands (packets) are transmitted from client to server, not from server to client, and hence these “reverse direction” channel buffers are not normally full of A/V data when streaming is occurring from the server to client. Second, in such systems normally multiple priority queues are implemented. Hence the control commands would usually be assigned a higher priority than the A/V data, and hence use a higher priority queue with a smaller (or no) backlog of data waiting for distribution through the system. This buffer-flushing may be implemented as control messages sent from the client, or by commands/messages sent by the server when the program changes.

FIG. 1 shows the additional components used to implement the invention in server-client system 10. Server 11 and client 12 contain control modules 23, 24 respectively. When the user inputs a “change program” command into control module 24 of client 12, control module 24 produces a Flush Buffer command which is input to modules 17 and buffers 18 to flush the buffers 18 in client 12. Control module 24 also communicates over link 14 to control module 23 which inputs the “flush buffer” command to modules 15 and buffers 16 to flush the buffers 16 in server 11.

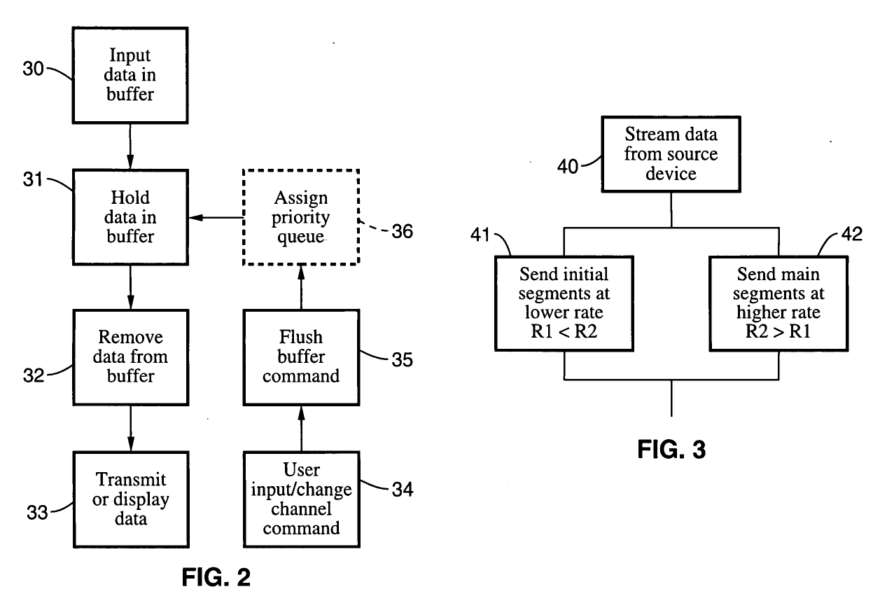

FIG. 2 is a flowchart illustrating this first method. Data is input into a buffer, step 30, where it is held, step 31, until it is removed from the buffer, step 32. The data removed from the buffer is either transmitted (from the server) or displayed (from the client), step 33. When the user initiates a “change channel” command, step 34, a “flush buffer” command is produced, step 35. The “flush buffer” command is used to cause data being held in the buffer (step 31) to be flushed. Optionally, the “flush buffer” command is assigned a priority queue, step 36, to prevent delays in its transmission.

Most buffers are implemented such that data contained within them can be read at any time, regardless of the amount of data in the buffer. However in some cases the buffer may be implemented such that the buffer accumulates data until it is full and only then it begins to output data (e.g. at a rate of one packet for every additional packet it receives) as in a FIFO. In this case, in addition flushing the buffers as just described, an additional method described below should also be implemented.

If it is desirable to further improve the performance of the buffer flushing method, and specifically to further decrease the latency, the initial segments of A/V data streamed are sent at lower A/V encoding quality. For example, if the main program is transmitted at data rates of 20 Mbps of MPEG-2 video, the initial segments are transmitted at a lower rate, e.g. 6 Mbps. This transrating of the A/V content can have been done prior to storing the content on the source device from which the streaming is occurring, or it can be done in realtime as the content is read off the storage medium. Hence each frame to be displayed comprises fewer bits, and can be transmitted and displayed with less delay.

This transrating process can be done by rate control unit 25, which is connected to source device 20 as shown in FIG. 1.

FIG. 3 is a flowchart of this second method of the invention. Data is streamed from the source device, step 40. The initial segments are sent at a lower rate, R1<R2, step 41. The main segments are sent at a higher rate, R2>R1, step 42. These segments can then be processed as before, e.g. stored in a buffer as in step 30 of FIG. 2.

In addition to the reasons explained above for FIFO type buffers, in some embedded systems is may be desirable to limit the amount of memory assigned to software buffers. In such cases an additional embodiment of the invention is implemented. When a program is first selected for viewing, buffer sizes are small. As the streaming continues, the buffer sizes are increased until the buffer size reaches the maximum desired buffer size. The maximum desired buffer size depends on the data rate and jitter, and is chosen to avoid buffer overflow and buffer underflow. As the buffer size is increased, the ability of the system to absorb jitter (due to packet retransmissions and other reasons) improves, helping to provide better quality of service (QoS) and hence video quality to the user viewing the client display.

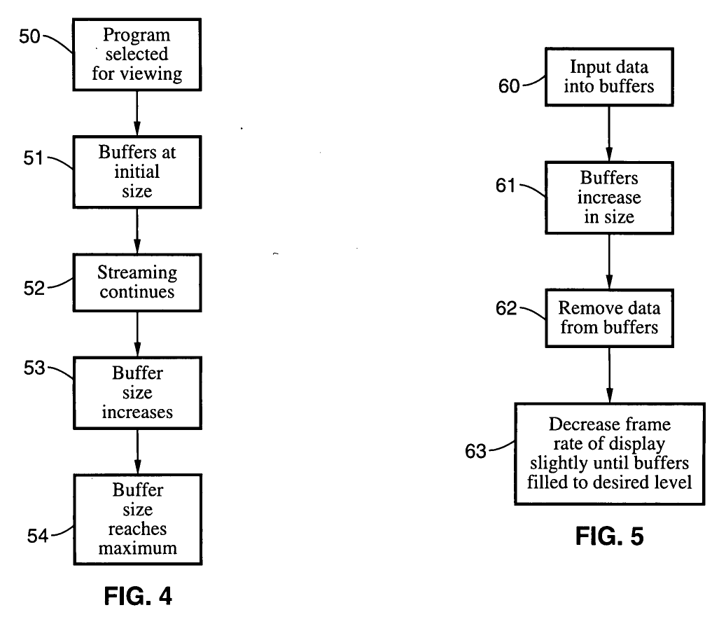

FIG. 4 is a flowchart of this third method of the invention. When a program is selected for viewing, step 50, the buffers are at their initial (smallest) size, step 51. As streaming continues, step 52, the buffer size increases, step 53, until the buffer size reaches the maximum, step 54.

FIG. 1 shows the apparatus to carry out this additional embodiment of the invention. This additional feature may also be included in control modules 23, 24 in addition to the flush buffer feature. When a program is first selected, and during streaming, control units 23, 24 provide Buffer Size signals to modules 15/data buffers 16, and modules 17/data buffers 18, respectively, to control the initial size and increase in size of the buffers. Either control module 23, 24 can initiate the process, depending on where the Program Selection command is generated, and communicate to the other control module over the link.

An implementation of this invention, depending on which of the three methods of FIG. 2 through FIG. 4 are implemented (any of the three can be used alone, but beneficially all three are preferably used together), may require that either the rate of data inputted to the system (to the server from the content source) be controllable, or the rate of data consumption (at the display driver on the client) be controllable, or both. This is required to be able to help partially fill the client buffers that are gradually being increased in size, so as to help absorb the jitter. This is accomplished easily when the server is reading pre-recorded data, since then the data can be read at “faster than real time” until the appropriate amount of buffer has been filled. Such pre-recorded sources include PVRs, A/V HDDs, some video-on-demand (VOD) content from the content provider/internet/headend, etc. For live programs it is not possible for the server to read the data ahead (into the future). In this case one option is to minimally and imperceptibly decrease the frame rate of the video being displayed on the client display, until the system buffers are filled to the desired level. At that point the frame rate may resume being the normal frame rate.

As shown in FIG. 1, Rate Control unit 25 controls the rate at which data is inputted to the system (to the server 11 from the content source 20). Consumption control unit 26, connected to the client 12, controls the rate of data consumption (at the display driver in the modules 17 on the client 12) to control the output to display device 21.

FIG. 5 is a flowchart of this additional feature of the invention. Data is input into buffers, step 60, the buffers increase in size, step 61, and date is removed from the buffers, step 62, as before. The frame rate of the display is decreased slightly until the buffers are filled to a desired level. As another example, If the (optional) flexible buffer sizes are not implemented, the buffer sizes remain fixed at some size; however, the rest of FIG. 5 remains the same, i.e. step 63 can be implemented without step 61. The flexible buffer sizes are needed only if it is necessary to conserve memory resources on the server and client.

The invention reduces latency in an A/V streaming system and improves a user's viewing experience. When a user at the client clicks on the “Play” button of the graphic user interface (GUI) on the screen to play a program off the server, there will be less delay before the video actually starts playing, providing the user with an increased sense of interactivity. Similarly when the user changes the viewed program, there will be less delay before the new program starts playing.

The invention is not specific to home streaming systems, but may be applied to any streaming systems, including streaming over cell-phone links, cable links, WLAN PAN, WAN, internet, etc.

A specific example of an A/V streaming system to which the present invention can be applied to reduce streaming latencies is an internet protocol television (IPTV) system. IPTV provides television (TV) communication using an internet protocol (IP) network. IPTV systems often include both broadcast and/or multicast content (either or both), as well as video-on-demand (VOD) content. The latencies produced in IPTV can be reduced according to the present invention using one or more of buffer manipulation, transrating content to lower data rates, selective multicasting, and local caches.

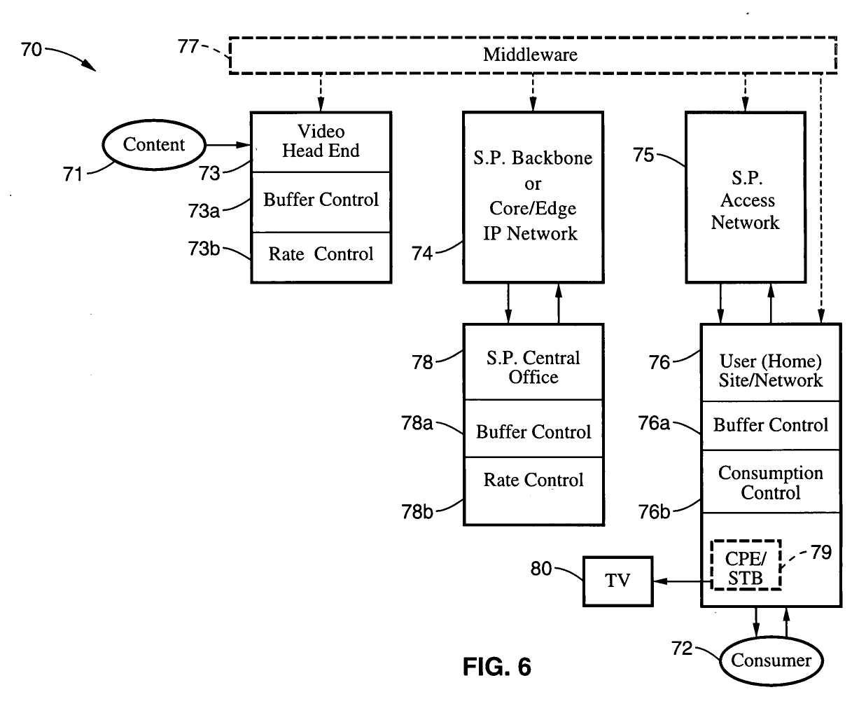

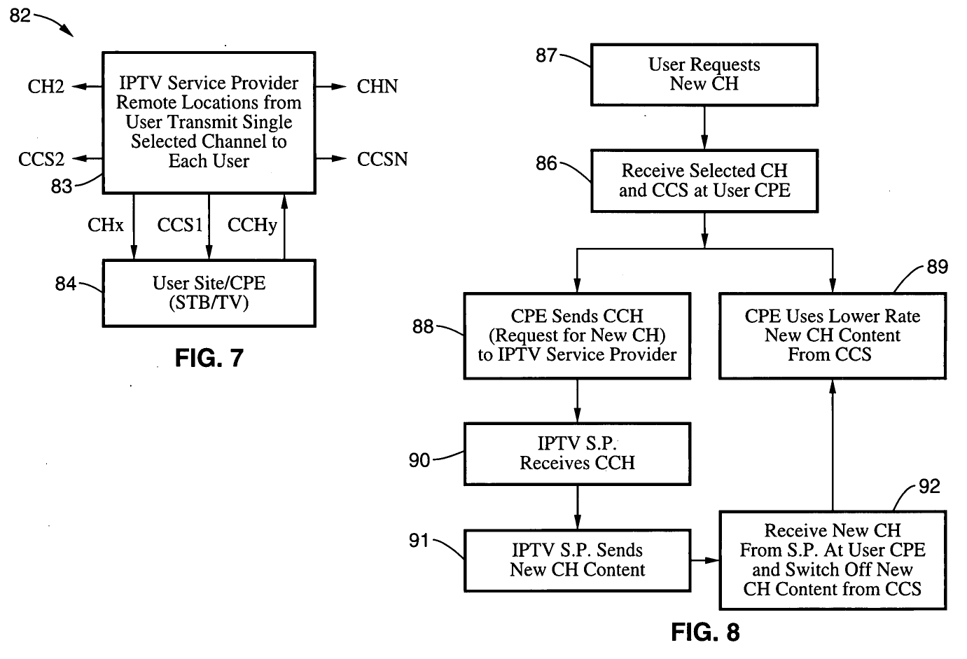

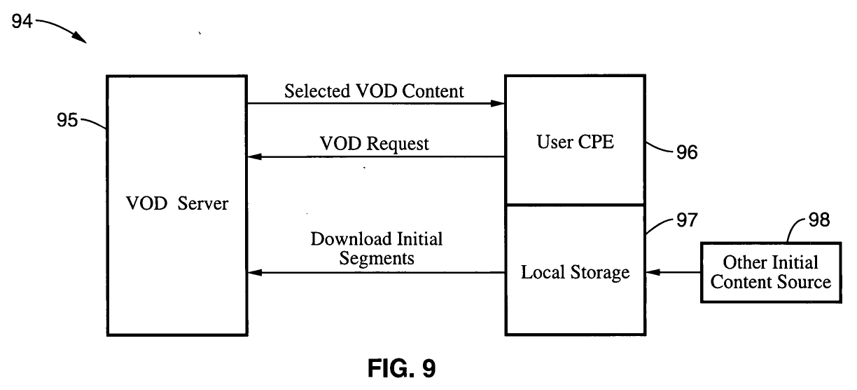

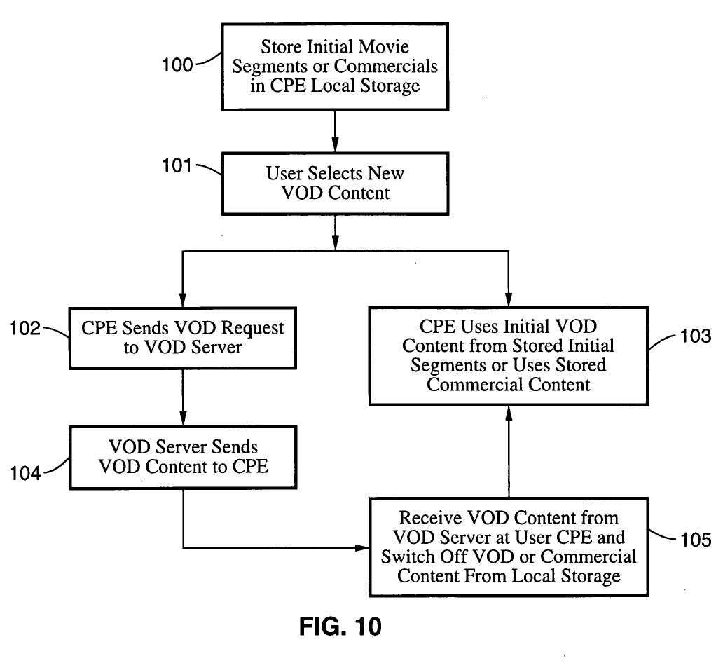

The methods described above to decrease A/V streaming latencies in server-client systems using buffer manipulation and by transrating content to lower data rates are also applicable to IPTV since IPTV is also an IP-based server-client streaming system. Thus the present invention includes applying those techniques to IPTV systems, as shown in FIG. 6. The present invention also provides two additional mechanisms specifically for multicast based networks such as IPTV. One technique, shown in FIG. 7 and FIG. 8, is suitable for implementation for broadcast/multicast A/V content while the other, shown in FIG. 9 and FIG. 10, is suitable for VOD A/V content.

An IPTV system (or network) 70, shown in FIG. 6, provides A/V content 71 to a consumer/user/customer/subscriber/viewer 72. IPTV system 70 has four major components: video head end 73, service provider backbone or core/edge IP network 74, service provider access network 75, and user (home) site (or network) 76.

The head end 73 is the portion of the IPTV system 70 where the A/V content 71, either linear content (e.g., broadcast TV channels) or on-demand content (e.g., movies) is captured and formatted for distribution over an operator's private IP network. The head end 73 receives content 71 from a variety of sources, including directly from the broadcaster or programmer, by various means, including satellites and fiber optic networks. The content 71 comes in various forms and formats, such as standard definition, high definition, music, analog, digital. The head end 73 takes the content and alters it to fit the operator's network, e.g. encoding it into a digital video format, typically MPEG-2. The encoded broadcast content is then encapsulated into IP and sent out over the network, typically as IP multicast streams. A higher level protocol (e.g., user datagram protocol (UDP)) is generally used in combination with IP. VOD content is similarly processed, and then placed on a server until requested.

Backbone or core/edge network 74 is the main part of the operator's IP network, and transports the encoded A/V streams, representing the channel line-up, and the VOD streams, from the head end 73 to access network 75. To minimize the strain on network bandwidth requirements, operators may cache popular content (e.g., current movies) at a “local” central office 78 closer to the user. The content can be streamed to the central office at low priority, at off-peak times, and by multicasting.

Access network 75 is the link from the edge portion of backbone network 74 to the individual user (home) site 76. Service providers are presently using digital subscriber line (DSL) technology to serve individual users, and are beginning to use fiber networks to the subscriber's premises such as passive optical networking (PON). IPTV networks may use high bandwidth DSL, PON, Broadband over Powerline, Coax, and other pipes to the home, office, or other location. The service provider may place a device like a DSL modem or optical network unit (ONU) at the user's premises to provide an Ethernet connection to the home site 76.

Home site 76 is the subscriber/user site and distributes the IPTV services throughout the site. Each site requires a demarcation device, e.g. a DSL modem or ONU, which provides connections for the user to connect the end-user or customer premises equipment (CPE). The end point of home site 76 is typically a set-top box (STB) 79 to which the TV set 80 is connected. STB 79 may support standard definition TV (SDTV), high definition TV (HDTV), integrated hard disks for recording programs, digital audio outputs for connecting to audio systems, web browsers, USB ports, and other features.

The network middleware 77, which is shown as separate but may be integrated into the system, is the software that controls the IPTV system 70 to deliver the IPTV service to the user. Middleware 77 is essentially the IPTV enabler, and typically provides a server-client architecture to the IPTV system 70. The user STB 79 is the client. The middleware 77 controls the user's interaction with the IPTV service.

Latencies in IPTV system 70 can be controlled using the techniques of buffer flushing and size change, and data transrating described above with reference to FIG. 1 through FIG. 5. As shown in FIG. 6, head end 73 and central office 78 contain buffer controls 73a, 78a and rate controls 73b, 78b, similar to those shown in FIG. 1, for carrying out similar functions. User site 76 contains buffer control 76a and consumption control 76b, similar to those shown in FIG. 1, for carrying out similar functions. These features are shown for illustrative purposes and may be implemented in many different specific embodiments in any part of the IPTV system 70, such as through middleware 77. Thus the service provider portion of the IPTV system of FIG. 6 is the server portion of the A/V streaming system of FIG. 1, and the user site is the client portion. Both portions contain buffers as shown in FIG. 1 that can be manipulated in the same ways.

An additional technique of decreasing streaming latencies is available for broadcast or multicast delivery of A/V content (e.g., standard broadcast or cable TV programming) in an IPTV system. FIG. 7 shows in very simplified functional form an IPTV system 82 having a service provider portion 83 and a user site 84. User site 84 is like user site 76 of FIG. 6 and service provider portion 83 represents the rest of the IPTV system; namely, all parts remote from the user site 76. An IPTV system or network has a switched digital video (SDV) architecture. In an SDV TV distribution system, only selected channels(s) are distributed to an individual connected user. A common protocol for switching channels in an SDV system is internet group membership protocol (IGMP).

In operation, service provider portion 83 transmits a single selected channel (CHx) to the user site 84, where it is received by the CPE at site 84 (e.g., an STB) and displayed on an associated TV. The particular channel CHx is the channel that has been selected out of the channel line-up by the user and is the only channel being provided to the customer at this time. It will be appreciated that there are many users connected to service provider portion 83 so that portion 83 is sending out many channels, but each user only receives the particular channel being viewed at that time. When a user wants to change to a new channel (CHy), the user requests CHy by actuating whatever control device is provided, and user site 84 sends a change channel request CCHy back to service provider portion 83, typically using IGMP. The process of requesting and providing the new channel introduces latencies.

In accordance with another aspect of the invention, the service provider will multicast or broadcast (either option may be used) one or more channel change streams (CCS). Each channel change stream contains content for one or more channels that are presently being broadcast by the IPTV service provider, but at a lower data rate compared to the primary channel (the channel that the viewer is presently watching). FIG. 7 shows a CCS channel CCS1 being transmitted from service provider portion 83 to user site 84 along with the selected channel CHx.

As an example, an IPTV service provider multicasts three HD (high definition) channels, CH1, CH2 and CH3. Each channel contains high definition A/V video codec data plus audio and related data, in a single program transport stream of 8 mbps. To implement the invention, the service provider now provides a fourth channel, the CCS channel containing the multi-program transport stream of all three channels, but at a much lower data rate, e.g. 800 kbps per channel. Therefore the CCS stream occupies only 2.4 mbps.

The decreased bit rate for CCS channel(s) is important for two main reasons. First, it does not occupy too much bandwidth on the last link from the service provider to the customer's site, which is important since these last links may support only low bandwidths, e.g. via ADSL2. Second, decoding the lower rate streams for display will introduce less latency than decoding a higher rate stream.

A consumer who would like to decrease IPTV channel change latencies would subscribe to this CCS channel from the service provider, using IGMP messages for a multicast implementation of CCS (for a broadcast implementation of CCS the consumer will already be receiving the CCS channel without having to send any special IGMP messages). When the user selects a new channel, the user site sends an IGMP message (CCH request) to the remote service provider's equipment to reroute the new channel to the user as it would normally do. However, in the meantime, the user's CPE (e.g. STB/TV) can immediately begin using the lower rate content for the new channel from the CCS channel. Once the rerouting information and content propagates through the network and the contents for the new HD (or SD) channel arrives at the STB/TV, the switch can be made from the CCS content to the actual channel's content.

As mentioned above, either a single CCS can be used or multiple CCS's can be used, and each CCS can cover one or more channels. For example, a CCS contains only one channel, and there are the same number of CCs channels as regular channels. For example, in addition to CH1, CH2 and CH3 being transmitted, the channels CH1-CCS, CH2-CCS and CH3-CCS would also be multicast. Each CCS channel's content would ideally be transrated down as illustrated above. FIG. 7 shows additional channels CH2, CHN and additional CCS channels CCS2, CCSN being transmitted from service provider portion 83. The user may then subscribe to only those CCS channels which he wants to support for fast channel change, e.g. the four channels higher in sequence number and the four channels lower in sequence number to the presently watched channel; and/or the next four channels and previous four channels in the user's “favorite channel” list.

FIG. 8 illustrates the method of the invention of using one or more CCS channels to decrease streaming latency in an IPTV network. A selected channel CHx and a CCS channel are received by the user CPE, step 86. When the user requests a new channel CHy, step 87, two steps occur simultaneously. The CPE sends a channel change request CCHy to the service provider, step 88, and the CPE starts to use the lower rate new channel content from the CCS channel, step 89. The CCHy request from step 88 is received by the IPTV service provider, step 90, and in response thereto the service provider sends the new channel content CHy to the user CPE, step 91. When the user CPE receives the new channel content CHy from the service provider, the user CPE switches off the new channel content from the CCS channel, step 92.

A further technique for decreasing streaming latencies is available for VOD delivery of A/V content. FIG. 9 shows in very simplified functional form an IPTV system 94 having a VOD server 95 and a user CPE 96. User CPE 96 is like user site 76 of FIG. 6 and server 95 represents the rest of the IPTV system, i.e. all parts remote from the user site 76. When the user CPE sends a VOD Request to the VOD server 95, server 95 transmits the selected VOD content through the network to the user CPE 96. Some may be streamed from VOD servers at the service provider head end whereas others may be cached closer to the end user, perhaps at a service provider's central office. The process of requesting and providing the VOD content introduces latencies.

In accordance with a further aspect of the invention, the user CPE 96 contains local storage (a local cache) 97, e.g. on a hard disk drive (HDD). Initial segments of a number of available movies are stored in local storage 97, and other content, such as commercials, may also be stored there. FIG. 9 shows initial segments of movies being downloaded from server 95 to local storage 97 of user CPE 95, as well as other content being input to local storage 97 from other initial content source 98.

A consumer who would like to decrease IPTV VOD latencies would store initial movie segments and/or other short content in local storage. When the user selects a new VOD content, the user site sends a VOD request to the remote service provider's equipment (servers) to route the new VOD content to the user as it would normally do. However, in the meantime, the user's CPE (e.g., STB/TV) can immediately begin using the initial segment from the local cache or else show the other content, e.g. a commercial. Once the routing information and VOD content propagates through the network and the VOD content arrives at the STB/TV, the switch can be made from the local cache content to the actual VOD content.

This aspect of the invention can use different types of data to fill the gap before VOD content arrives. Commercials or other brief information are stored locally, and updated periodically, on the CPE hard disk drive or other storage connected to the STB/TV or related network. These short ads or other information are presented to the consumer to hide the initial viewing latency when new VOD content is selected. Initial segments of movies for which startup latencies are expected to be large are stored on the CPE hard disk drive or other storage connected to the STB/TV or related network. When the user selects VOD content (a movie), the movie starts streaming immediately from the locally stored initial segment (possibly at a lower data rate than the actual content will be), while the CPE sends the VOD request to the content provider VOD servers. After a few seconds when the actual content from the VOD servers arrives, the CPE switches to this actual content which continues playing.

FIG. 10 illustrates the method of the invention of using local storage to decrease streaming latency in an IPTV VOD network. Initial segments of movies or commercials or other content are stored in the user CPE local storage, step 100. When the user selects new VOD content, step 101, two steps occur simultaneously. The CPE sends a VOD Request to the VOD server, step 102, and at the same time, the CPE starts to use the initial VOD content from the stored segments, or uses the stored commercials or other data, step 103. In response to the VOD request, the VOD server sends the VOD content to the CPE, step 104. When the user CPE receives the new VOD content from the VOD server, the CPE switches off the content from the local storage, step 105.

Local storage on the consumer's HDD or other storage should be adequate. For example, if this “initial partial cache” (as these initial stored segments may be considered) is maintained on the consumer's hard disk drive (HDD) for the first 5 seconds of each of 1000 movies available at the VOD server, if all VOD movies are HD and the local cache is maintained at SD, then 1000 (movies)×5 (sec)×1 (mbps)=5000 mbits, or 625 mbytes, of content, which is not much for a readily available 200 gigabyte HDD. This initial partial cache may be downloaded during non-peak hours, and need be updated only when the VOD movie library changes at the VOD server.

Thus the invention provides additional methods for reducing latency in IPTV systems. The techniques shown in FIG. 7 and FIG. 8 for broadcast A/V content and the techniques shown in FIG. 9 through FIG. 10 for VOD content have a unifying concept that applies to all IPTV systems. In both types of systems, the problem is that there is a delay before the service provider can provide new A/V content to a user when the user requests it because of delays built into the system. In both cases, the solution according to the invention is basically the same, to provide a separate source of the selected A/V content to the user that is immediately available to the user when the user requests the A/V content, and that can be used until the requested A/V content is received from the service provider. The separate source may not be as good (e.g., lower data rate) or as complete (e.g., only initial segments) but it is only needed for a short time, to fill the gap until the regular A/V content is received from the service provider. The only difference is the particular way in which the temporary separate source is provided, by a separate CCS channel already being received by the user from the service provider, or by initial segments of the A/V content that have already been stored at the user site.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A method for reducing latency due to buffers in an internet protocol television (IPTV) A/V streaming system, comprising:
streaming data into buffers in the IPTV A/V streaming system;
holding streamed data in the buffers until removed;
removing streamed data from the buffers for transmission or display; and
performing at least one of the following:
(i) flushing held data from the buffers in response to a change program command;
(ii) sending initial segments of data from a source device to the buffers at a first rate and sending the remaining segments of data from the source device to the buffers at a second rate higher than the first rate; and
(iii) starting the buffers at an initial size when a program is first selected for viewing and increasing the buffers as streaming continues until buffer size reaches a maximum.

2. An internet protocol television (IPTV) A/V streaming system, comprising:
a service provider IPTV server, including buffers;
a user site client, including buffers; and
a communications channel connecting the server and client;
the server and client each containing a buffer control module which generates at least one of:
(i) a flush buffer command in response to a user initiated change program command to flush the buffers in the server and client; and
(ii) a buffer size control signal to increase the sizes of the buffers from initial sizes to maximum sizes;
the server containing a rate control module and the client containing a consumption control module.

3. An internet protocol television (IPTV) system for providing broadcast or multicast A/V content, comprising:
an IPTV service provider section which provides any of a plurality of available channels of broadcast or multicast A/V content to a connected user;
an IPTV user site communicating with the service provider and receiving only a single selected channel of A/V content at a time from the service provider section; and
one or more channel change stream (CCS) channels also being broadcast or multicast from the service provider section to the user site, each CCS channel containing content for one or more of the available channels of A/V content but at a lower data rate than the data rate of A/V content received over a selected channel;
wherein when a user requests a new channel from the service provider section, the user site will utilize the A/V content for the newly selected channel from a CCS channel already being received at the user site until the newly selected channel is received at the user site, thereby decreasing channel change latency.

4. A method for decreasing channel change latency in an internet protocol television (IPTV) system, comprising:
receiving at an IPTV user site only a single selected channel of A/V content at a time from a service provider section which provides any of a plurality of available channels of A/V content to a connected user;
receiving at the user site one or more channel change stream (CCS) channels also being broadcast or multicast from the service provider section to the user site, each CCS channel containing content for one or more of the available channels of A/V content but at a lower data rate than the data rate of A/V content received over a selected channel; and
utilizing at the user site the A/V content for a newly selected channel from a CCS channel already being received at the user site when a user requests a new channel from the service provider section until the newly selected channel is received at the user site.

5. An internet protocol television (IPTV) system for providing video-on-demand (VOD) A/V content, comprising:
an IPTV VOD server which provides any of a plurality of stored VOD A/V content to a connected user upon request by the user; and
an IPTV user site communicating with the VOD server and receiving selected VOD A/V content from the VOD server;
the IPTV user site comprising consumer premises equipment (CPE) having local storage, the local storage containing initial segments for at least some of the available stored VOD A/V content or other segments of information;
wherein when a user requests new VOD A/V content from the VOD server, the user site CPE will utilize an initial segment of the requested VOD A/V content or other information from the local storage until the newly requested VOD A/V content is received at the user site CPE, thereby decreasing VOD streaming latency.

6. The IPTV system of claim 5, wherein the CPE local storage comprises a hard disk drive.

7. The IPTV system of claim 5, wherein the VOD server is located in a service provider head end or in a service provider central office.

8. A method for decreasing streaming latency in an internet protocol television (IPTV) system for providing video-on-demand (VOD) A/V content, comprising:
storing initial segments of available VOD A/V content or other content in a user site consumer premises equipment (CPE) local storage; and
utilizing at the user site CPE an initial segment of the requested VOD A/V content or other information from the CPE local storage when the user requests new VOD A/V content from the VOD server until the newly requested VOD A/V content is received at the user site CPE.

9. The method of claim 8, wherein the initial segments of VOD content are stored in the CPE local storage by downloading from the VOD server.

10. A method for decreasing streaming latency in an internet protocol television (IPTV) system, comprising:
requesting new A/V content from an IPTV service provider; and
providing a separate source of the selected A/V content to the user that is immediately available to the user when the user requests the A/V content, and that can be used until the requested A/V content is received from the service provider.

11. The method of claim 10, wherein the separate source is contained in a channel change stream (CCS) channel broadcast or multicast from the service provider to the user.

12. The method of claim 10, wherein the separate source is contained in a local user storage in the form of initial segments of the A/V content.

13. An internet protocol television (IPTV) system, comprising:
an IPTV service provider;
an IPTV user connected to the service provider and receiving selected A/V content; and
a separate source of the selected A/V content to the user that is immediately available to the user when the user requests the A/V content, and that can be used until the requested A/V content is received from the service provider.

14. The IPTV system of claim 13, wherein the separate source comprises a channel change stream (CCS) channel broadcast or multicast from the service provider to the user.

15. The IPTV system of claim 13, wherein the separate source is a local user storage containing stored initial segments of the A/V content.
